(19) United States
(12) Patent Application Publication
(10) Pub. No.: US 2006/0029152 A1
(43) Pub. Date: Feb. 9, 2006

(54) Digital communications transmitter with synthesizer-controlled modulation and method therefor

(75) Inventors: Robert Roy Kost, Gilbert, AZ (US); Michael Kip Eugene Waldo, Phoenix, AZ (US); Kent Lynn Torell, Phoenix, AZ (US)

Correspondence Address: Lowell W. Gresham;Meschkow & Gresham, PLC, Suite 409, 5727 North Seventh Street, Phoenix, AZ, 85014, US

(73) Assignee: General Dynamics Decision Systems, Inc., Scottsdale, AZ (US)

(21) Appl. No.: 10/910,195

(22) Filed: Aug. 3, 2004

(51) Int. Cl. H04L 27/20

(52) U.S. Cl. 375/295

(57) ABSTRACT

A low-power digital communications transmitter (20) includes a programmable digital-processing circuit (22), which may be provided by a digital signal processor (DSP), a programmable direct digital synthesizer (DDS), and a constant-envelope, high power amplifier (32). The DDS (24) is programmed to provide pulse-shaping and IF/RF signal modulation functions. The digital-processing circuit (22) produces only one sample per unit interval (134) and is programmed so that the one sample per unit interval (134) is a frequency-profile index symbol (52″) produced from a I,Q baseband symbol (52′). The DDS (24) converts each frequency-profile index symbol (52″) into a frequency profile (130) that controls the frequency of a synthesizer (56) to induce modulation into a periodic output (68) of the synthesizer. Moreover, the frequency profile (130) is configured to confine spectral emissions within a spectral mask (140).

### TECHNICAL FIELD OF THE INVENTION

The present invention is related to low-power, digital-communications transmitters.

### BACKGROUND OF THE INVENTION

Reducing power consumption in radio-frequency (RF) transmitters is always a desirable goal. But in some applications low power consumption is more important than merely being a desirable goal. For example, in battery-powered applications, low power consumption is more important. Greater power consumption causes batteries to drain faster. Consequently, either larger or heavier batteries must be used, or more expensive and exotic batteries must be used. On the other hand, when power consumption can be reduced, smaller batteries may be used to reduce the size and weight of the transmitter, or a longer operating time results from maintaining a constant battery size.

In some battery-powered applications, low power consumption is still even more important than in others. For example, where small size and/or low weight are requirements of the application, getting the most efficient use of a small battery is of great importance. Or, when limited opportunities are available for replacing or recharging batteries, such as in transmitters placed in remote locations, using the battery reserves frugally is of great importance. Likewise, in space-based applications where additional power consumption leads to increased weight and size in solar cells and to increased weight and size in heat management systems, using the battery reserves frugally is also of great importance. In these and other applications, a strong need exists to minimize power consumption.

When low power consumption is a primary focus of an RF transmitter, a constant-envelope form of modulation may be more preferable, even though a more efficient use of allocated spectrum may be obtained by using a form of amplitude modulation. Constant-envelope modulations do not require the use of linear amplifiers. Linear amplifiers tend to be less efficient (i.e., to consume more power for a given broadcast signal level) and to be more expensive. Moreover, in order to minimize spectral regrowth, linear amplifiers either tend to be operated at large backoff, where they are particularly inefficient, or to be designed with expensive and power-hungry linearization circuits.

But conventional digital communications transmitters that have low power consumption as a primary focus pay scant attention to the digital and analog signal processing taking place upstream of the power amplifier. Consequently, such processing tends to be conducted in a manner that leads to undesirable power consumption. For example, it has become customary to insert pulse-shaping filters immediately after digital modulation. The pulse shaping filters achieve the desirable effect of spreading the energy from each symbol over a plurality of unit intervals or chips so that the RF signal eventually broadcast from the transmitter will be confined within a reasonably small spectral bandwidth. As a result, the phase transition from symbol-to-symbol tends to be smoothed out rather than abrupt. In order to minimize inter-symbol interference (ISI) a Nyquist, raised-cosine, or other filter is often implemented. But such a filter uses a significant number of processing circuits and often necessitates an increase in clock rate, so that in many cases at least twice the amount of data needs to be processed within a given block of time in the pulse-shaping filter and all digital circuits downstream of the pulse-shaping filter. Thus, the conventional pulse-shaping filter increases power consumption both in the filter itself and downstream of the filter.

Furthermore, due at least in part to the quantity of data to be processed, conventional transmitters have used field-programmable logic arrays (FPLA's) to digitally process the data being communicated. The use of FPLA's allows the integration of a significant amount of digital processing on a common semiconductor substrate, which leads to power savings over using a less integrated approach. But the use of FPLA's still causes excessive power consumption because different parts of the chip typically cannot be managed differently for power consumption purposes. Inefficient power management results.

And, conventional digital communications transmitters that have low power consumption as a primary focus tend to provide separate circuits of significant complexity for pulse-shaping and for intermediate frequency (IF) or RF modulation. This practice leads to the inclusion of additional data processing and/or processing circuits and again results in increased power consumption.

### SUMMARY OF THE INVENTION

Accordingly, it is an advantage of the present invention that an improved digital communications transmitter with synthesizer-controlled modulation and method are provided.

Another advantage of the present invention is that pulse-shaping and IF/RF modulation functions are combined.

Another advantage of the present invention is that a digital synthesizer is controlled to provide both IF/RF modulation and pulse shaping.

Yet another advantage of the present invention is that the significant power-consuming components can be limited to a high-power amplifier (HPA) and two semiconductor devices.

These and other advantages of the present invention are carried out in one form by a digital communications transmitter which includes a digital-processing circuit configured to generate a digitally-modulated symbol for each unit interval. A frequency-profiling circuit is configured to generate a plurality of digitally-specified frequencies per unit interval in response to each digitally-modulated symbol. The digitally-specified frequencies are arranged so as to confine radio-frequency (RF) emissions within a predetermined spectral mask. A digital synthesizer has a frequency input that couples to the frequency-profiling circuit and has a periodic output. The periodic output of the digital synthesizer couples to a digital-to-analog converter.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a block diagram of a digital communications transmitter configured in accordance with one embodiment of the present invention;

FIG. 2 shows a block diagram of a digital-processing circuit from FIG. 1;

FIG. 3 shows a block diagram of a mapping circuit from FIG. 2 which generates frequency-profile indexes;

FIG. 4 shows a phase-point diagram for QPSK modulation, which is one of many different modulation types the digital communications transmitter of FIG. 1 can be adapted to accommodate;

FIG. 5 shows a table depicting one exemplary mapping function that may be implemented in the mapping circuit from FIG. 3 to accommodate the QPSK modulation example of FIG. 4;

FIG. 6 shows a graph depicting data level over time in a memory of the digital-processing circuit from FIG. 2 and in relation to a standby signal;

FIG. 7 shows a block diagram of a direct digital synthesizer (DDS) from FIG. 1;

Each of FIGS. 8-11 shows a different frequency profile which may be implemented through the frequency-profiling circuit from FIG. 7 to accommodate the QPSK modulation example of FIG. 4; and

FIG. 12 shows a graph depicting an exemplary spectral mask that a frequency-profiling circuit from FIG. 7 may accommodate.

### DETAILED DESCRIPTION OF THE PREFERRED EMBODIMENTS

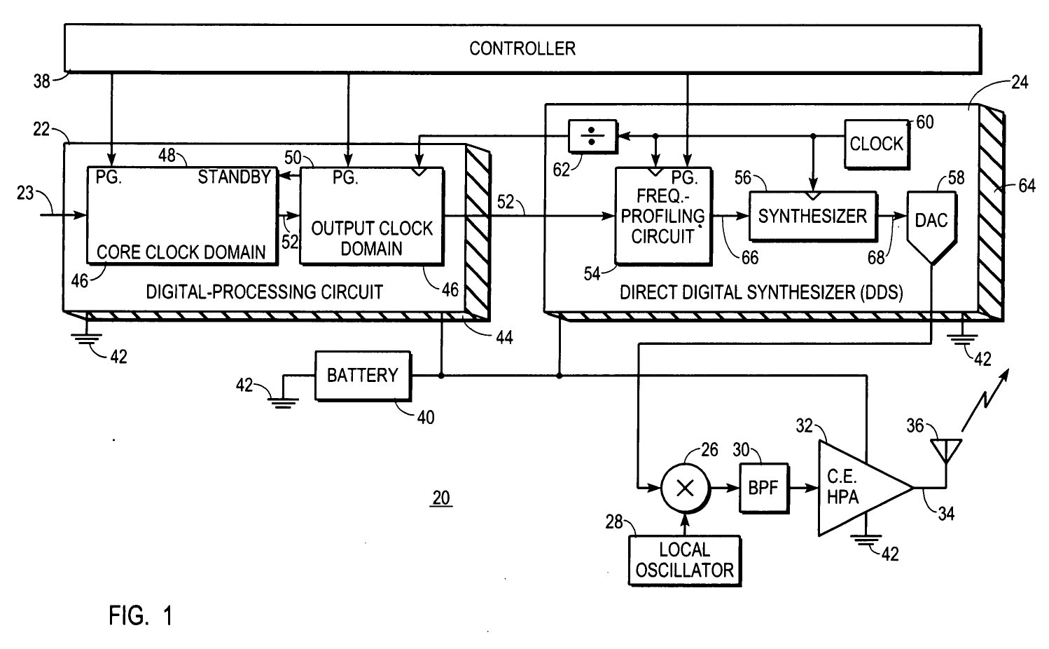

FIG. 1 shows a block diagram of a digital communications transmitter 20 configured in accordance with one embodiment of the present invention. Transmitter 20 includes a digital-processing circuit 22, which receives the payload data to be communicated from transmitter 20 at an input port 23, and a direct digital synthesizer (DDS) 24, which performs pulse-shaping and which performs at least modulation of an intermediate-frequency (IF) carrier, and possibly modulation of a radio-frequency (RF) carrier. DDS 24 couples to digital-processing circuit 22 in a manner discussed in more detail below.

In the preferred embodiment, if the carrier frequency is less than a few hundred MHz, then an analog output from DDS 24 can serve as an RF carrier signal. When the carrier frequency is more than a few hundred MHz, then the analog output from DDS 24 is an IF signal that couples to a first input of a mixer 26. A second input of mixer 26 couples to an output from a local oscillator 28, and an output of mixer 26 serves as an RF carrier signal. This RF carrier signal is routed through a band-pass filter (BPF) 30 and then drives a constant-envelope (C.E.), high-power amplifier (HPA) 32. HPA 32 generates an amplified signal 34 broadcast from transmitter 20 at an antenna 36. The use of a constant-envelope HPA is desirable in low-power transmitter 20 because constant-envelope HPA's are typically more power efficient and less costly than linear and other types of HPA's conventionally used in digital communications transmitters. In addition, it permits the omission of HPA-linearization circuits and processing techniques often necessary when linear HPA's are used.

In the preferred embodiment, digital-processing circuit 22 and DDS 24 are both highly-programmable components. Thus, transmitter 20 may be used in a software-defined radio that can support a wide variety of communication formats. A controller 38 couples to digital-processing circuit 22 and to DDS 24 to provide the programming suitable for a communication format to be used by transmitter 20, and that communication format may change from time-to-time under the management of controller 38. But nothing requires the presence of controller 38, and digital-processing circuit 22 and DDS 24 may be factory-programmed to implement a desired communication format much less amenable to change.

While a wide variety of digital-communications-transmission applications may benefit from the power-lowering accomplishments of the present invention, such accomplishments are better appreciated in battery-energized applications, and still better appreciated in battery-energized applications in which small battery size and/or extended operating time are particularly important goals. Thus, transmitter 20 includes a battery 40 which couples to a contact 42 adapted to receive a ground potential and to power inputs of digital-processing circuit 22, DDS 24, and HPA 32. Battery 40 may be implemented using any of the electrochemical power sources known to those skilled in the art, but the power supplied by battery 40 may be supplemented from other power generation sources (not shown), such a solar cells, wind turbines, and the like. Those skilled in the art will appreciate that the power available from battery 40 is limited and that greater power-efficiency in the circuits of transmitter 20 will allow transmitter 20 to operate longer.

Digital-processing circuit 22 may be adequately provided by a commercially available digital-signal processor (DSP) which is highly programmable, such as the TMS320VC5509 DSP available from Texas Instruments, Inc. Accordingly, digital-processing circuit 22 includes many different circuits formed on a common substrate 44, with substantially all of such circuits being energized from battery 40. These different circuits are organized within digital-processing circuit 22 into different clock domains 46. Circuits within each clock domain 46 generally operate synchronously with one another and at a common internal voltage level. But different clock domains 46 may operate asynchronously from one another and may operate at different voltage levels. Thus, one clock domain 46, such as a core clock domain 48, may be placed in a standby mode of operation to conserve power while other clock domains 46, such as an output clock domain 50, remain fully functional. When a clock domain 46 is in its standby mode of operation it performs little or no data processing, but consumes very little power. By integrating several different clock domains 46 together on a common semiconductor substrate 44, power consumption is reduced compared to a less integrated approach, and the different clock domains 46 allow power consumption to be managed for even further reduced power consumption.

Core clock domain 48 provides baseband, digitally-modulated symbols 52 to output clock domain 50, and output clock domain 50 provides the baseband digitally-modulated symbols 52 to DDS 24. Thus, output clock domain 50 provides an output port for digital-processing circuit 22.

A symbol 52 is a unit or collection of formatted, encoded, and modulated data to be transmitted during a unit interval. Symbols 52 may consist of any number of bits of data. A unit interval is the period of time required by transmitter 20 to transmit a symbol 52 of data. It is the shortest time interval between two consecutive significant instants. Transmitter 20 transmits symbols 52 over a duration that is an integer multiple of unit intervals. When a spread spectrum communication format is employed by transmitter 20, then the unit of time known as a “chip” is also considered a unit interval for purposes of the present invention. Throughout digital-processing circuit 22, symbols 52 are desirably formed and transferred at an effective rate of one symbol per unit interval. By keeping clock periods used in digital-processing circuit 22 at the unit interval, power is conserved, particularly when compared to transmitters that include pulse-shaping filtering which must be operated at higher data rates.

In one preferred embodiment, battery reserves are better preserved by operating core clock domain 48 for short bursts of time at a clock rate much faster than dictated by the unit interval, then placing core clock domain 48 in its standby mode of operation. Nevertheless, the effective rate achieved by combining the standby duration with the short burst period approximates the effective rate of one symbol per unit interval.

DDS 24 includes a frequency-profiling circuit 54 which receives the baseband digitally-modulated symbols 52 from digital processing circuit 22. DDS 24 also includes a synthesizer 56, digital-to-analog converter (DAC) 58, clock circuit 60, and division circuit 62. These and other components (not shown) which may be included in DDS 24 are formed on a common semiconductor substrate 64 for reduced power consumption and are energized by battery 40. Substrate 64 on which DDS 24 is formed is different from substrate 44 on which digital-processing circuit 22 is formed. This permits entirely different semiconductor-formation processes to be employed with substrates 44 and 64. DDS 24 operates at a greater internal clock rate than digital-processing circuit 22 in the preferred embodiment, and DDS 24 may be formed using a semiconductor-formation process optimized for higher-speed operation than digital-processing circuit 22. DDS 24 may be adequately provided by a commercially available direct digital synthesizer which is highly programmable, such as the AD9954 component from Analog Devices, Inc.

Frequency-profiling circuit 54 and synthesizer 56 each operate at a relatively high clock rate, determined by a clock signal generated by clock circuit 60. This clock signal is divided down to a lower rate in division circuit 62 and coupled back to serve as a master clock signal for output clock domain 50 of digital-processing circuit 22. Thus, output clock domain 50 operates synchronously with frequency-profiling circuit 54 and synthesizer 56 of DDS 24.

Due to operation at a relatively high clock rate, frequency-profiling circuit 54 outputs several different frequency values during each unit interval. The set of frequency values, or frequencies, output from frequency-profiling circuit 54 during any single unit interval represents a frequency profile. The stream of frequencies and frequency profiles are routed from frequency-profiling circuit 54 to a frequency input 66 of synthesizer 56. Synthesizer 56 has a periodic output 68 which generates a digital representation of a periodic signal modulated by the frequency profiles presented at frequency input 66. This digital representation consists of a plurality of different digital values produced at periodic output 68 throughout each unit interval. DAC 58 converts the digital representation of the periodic signal into an analog signal that is then output from DDS 24 and from semiconductor substrate 64 and provided to mixer 26 or BPF 30.

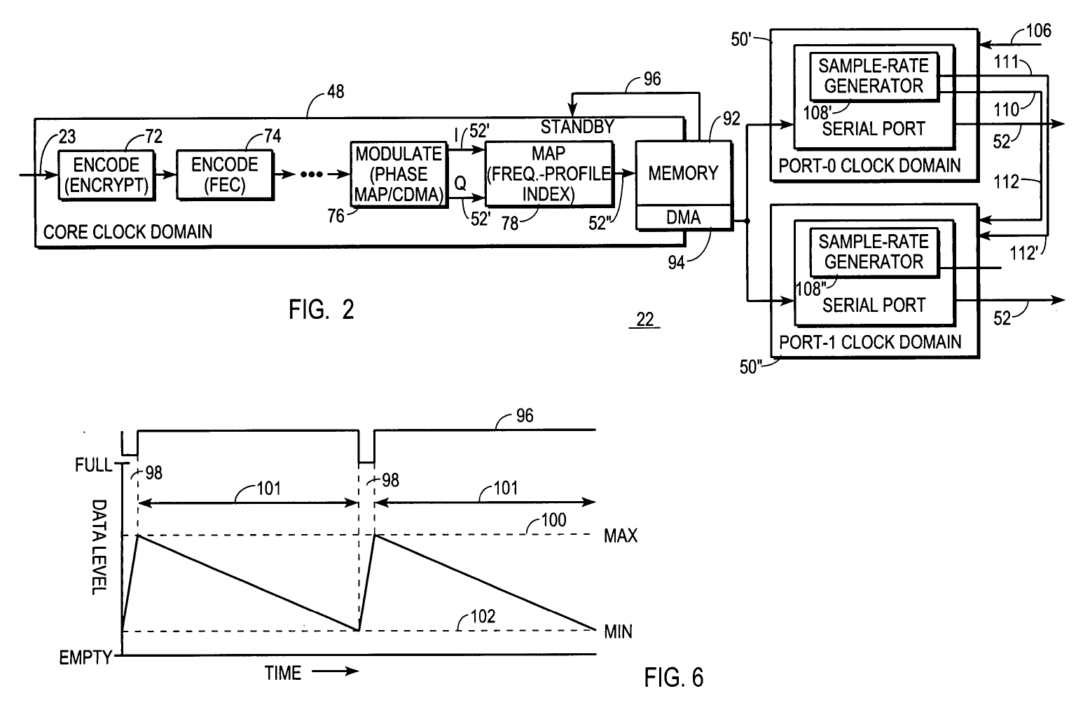

FIG. 2 shows a block diagram of digital-processing circuit 22 which presents details omitted from FIG. 1. Core clock domain 48 is depicted as now having been programmed by controller 38 (FIG. 1) to perform a variety of encoding, formatting, and/or mapping functions. Those skilled in the art will appreciate that the number and nature of the various encoding and mapping functions programmed into core clock domain 48 will vary from communication format to communication format. The specific functions depicted in FIG. 2 are presented for illustrative purposes only, and the manner in which such functions are carried out is beyond the scope of the present invention.

Thus, input payload data 70 may be encoded, such as by encryption, in a block 72, then further encoded, for example to implement forward-error correction (FEC), in a block 74. As suggested by ellipsis in FIG. 2, any number of encoding and formatting operations may be implemented in core clock domain 48. Eventually, the to-be-communicated data are passed to a modulation block 76 which implements phase mapping, as is common with PSK modulation formats, and/or spreading in response to pseudo-random codes, as is common with CDMA modulation formats. Modulation block 76 represents yet another encoding stage that takes place at baseband. Modulation block 76 produces in-phase (I) and quadrature (Q) complex components of the data, now configured as symbols 52′. Preferably, one set of in-phase and quadrature data are produced for each unit interval. Beginning with modulation block 76 and traversing downstream, each collection of data generated for any single unit interval may be referred to as a symbol 52.

Complex I,Q baseband symbols 52′ pass from modulation block 76 to a mapping block 78. Mapping block 78 maps the complex I,Q baseband symbols 52′ into frequency-profile index symbols 52″. One mapping is performed for each unit interval.

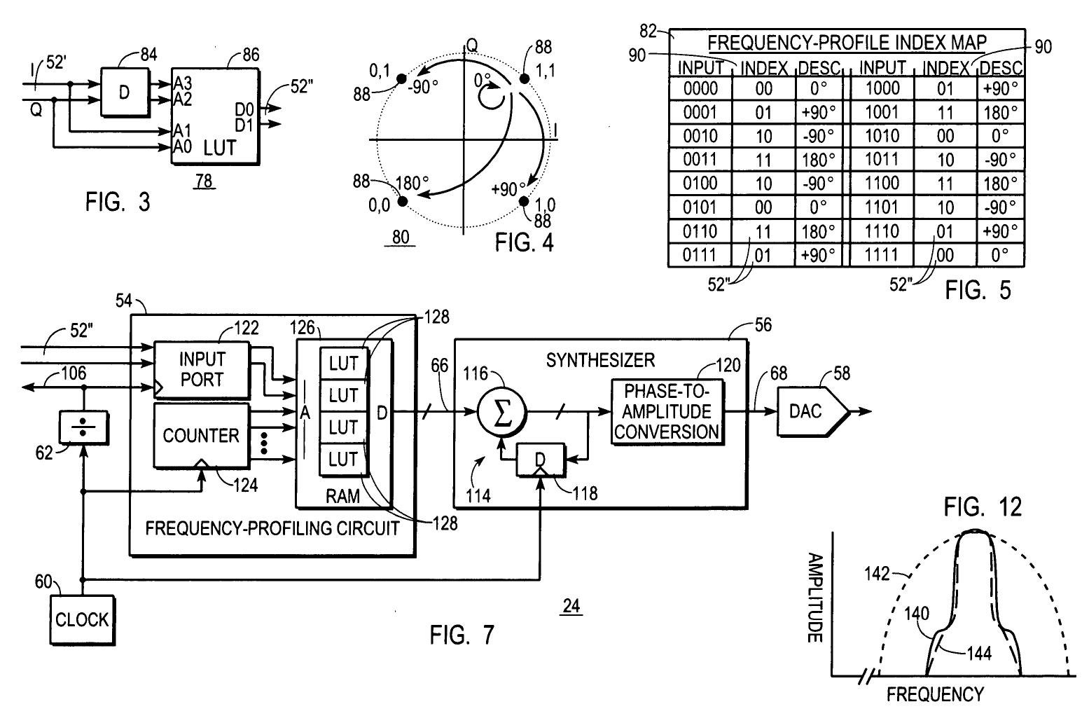

FIG. 3 shows a block diagram of an exemplary mapping block 78, while FIG. 4 shows a phase-point diagram 80 for QPSK modulation, which is only one of many different modulation types digital communications transmitter 20 can be adapted to accommodate, and FIG. 5 shows a table 82 depicting one exemplary mapping function that may be implemented by the particular embodiment of mapping block 78 depicted in FIG. 3 to accommodate the QPSK modulation example of FIG. 4. For consistency, a QPSK modulation example is followed throughout the Figures. But those skilled in the art will understand that a wide variety of preferably constant-envelope modulation forms may also be implemented, that the QPSK particulars discussed herein need not be followed for other modulation forms, and that the present invention is not limited to implementing only the QPSK modulation form. In accordance with the QPSK modulation example, each complex I,Q baseband symbol 52′ has two bits of data, one of which identifies an in-phase state and the other of which identifies a quadrature state.

Referring to FIG. 3, complex I,Q baseband symbols 52′ are delayed one unit interval in a delay stage 84 and applied directly to two least-significant address inputs of a look-up table (LUT) 86. LUT 86 may be implemented as a random access memory (RAM) that has been programmed by controller 38 (FIG. 1) or at a manufacturing facility. Delayed I,Q baseband symbols from delay stage 84 are applied to two most-significant address inputs of LUT 86. Thus, the most-significant address bits of LUT 86 are driven by the symbol from the previous unit interval, and the least-significant address bits of LUT 86 are driven by the symbol for a current unit interval.

Referring to FIG. 4, phase point diagram 80 depicts four phase points 88, which schematically represent the only four possible I,Q phase states permitted in accordance with QPSK modulation. During each unit interval, only one of the four phase points 88 is described by the symbol 52′ for the unit interval. As depicted by a dotted-line circle in FIG. 1, all phase points 88 are equidistant from the I-Q axes′ origin as is typical of a constant-envelope form of modulation. Four curved arrows are associated with a phase point 88, which FIG. 4 also labels with the coordinates of “1,1”. These four curved arrows depict the four different possible phase transitions that may occur while moving from the “1,1” coordinates in one unit interval to the four possible phase points 88 in the next unit interval. In other words, the I,Q phase may transition either 0°, +90°, −90°, or 180° between unit intervals. While the curved arrows are provided in FIG. 4 for only one of phase points 88, the same relationships hold for all phase points 88. Of course, those skilled in the art will appreciate that these specific phase point relationships are relevant only for QPSK modulation and that other modulation forms may very well have other relationships.

Referring to FIG. 5, table 82 illustrates one exemplary set 90 of frequency-profile index symbols 52″ that may be programmed in LUT 86 of mapping block 78 (FIG. 3). Input addressing is consistent with the FIG. 3 mapping block 78 embodiment to describe all possible combinations of transitions between phase points 88. A frequency-profile index 52″ is arbitrarily assigned for each possible transition that may take place between unit intervals. In addition, table 82 lists a phase transition description (0°, +900, −90°, or 180°) to which the frequency-profile indexes 52″ have been assigned. Accordingly, for each unit interval, a complex baseband I,Q symbol 52′ is mapped into a frequency-profile index symbol 52″ that a phase transition needs to follow in order to transition from the last symbol to the current symbol.

Referring back to FIG. 2, frequency-profile indexes 52″ are written to a memory 92, preferably configured as two circular buffers for the QPSK modulation example, with one circular buffer for each bit of frequency-profile indexes 52″. Memory 92 is associated with a direct memory access (DMA) controller 94 and is located at a boundary of core clock domain 48. As mentioned above, core clock domain 48 may operate for a brief period of time at a speed which generates more, and even many more, than one frequency-profile index 52″ per unit interval. During this brief period, power consumption is relatively high.

FIG. 6 shows a graph depicting data level over time in memory 92 and in relation to a standby signal 96, which controls the standby mode of operation for core clock domain 48. As shown in FIG. 6, core clock domain 48 may operate for a brief period of time 98 while a standby signal is inactive. During period 98, memory 92 is filled by core clock domain 48 with frequency-profile indexes 52″. At all times when transmitter 20 is operating, including periods 98, frequency-profile indexes 52″ are removed from memory 92 at substantially the rate of one frequency-profile index 52″ per unit interval. Frequency-profile indexes 52″ are removed through DMA in a manner that does not require core clock domain 48 to be active. But during periods 98 frequency-profile indexes 52″ are written into memory 92 faster than they are removed, and the data level in memory 92 increases.

When a maximum level 100 for memory 92 is reached, memory 92 then activates standby signal 96, causing core clock domain 48 to cease data processing activities, to refrain from writing to memory 92, and to consume very little power. Then, for another period of time 101 frequency-profile indexes 52″ continue to be removed from memory 92 through DMA, preferably in a first-in, first-out (FIFO) order, until the amount of indexes 52″ reaches a minimum level 102 for memory 92. At this point, standby signal 96 goes inactive, and core clock domain 48 again processes data and writes to memory 92 until maximum level 100 is reached. Thus, core clock domain 48 occasionally operates in a standby mode until previously generated symbols 52″ are output from digital-processing circuit 22.

Referring back to FIG. 2, output clock domain 50 from FIG. 1 is now shown as being two separate serial-port clock domains 50′ and 50″. Serial-port clock domains 50′ and 50″ may be configured identically, but operate independently from one another due to their placement in different clock domains. In this embodiment, a clock signal 106 generated in DDS 24 is supplied to a port-0 clock domain 50′, and particularly to a sample-rate generator 108′ of port-0 clock domain 50′. Sample-rate generator 108′ is programmed from controller 38 (FIG. 1) to divide the rate of clock signal 106 down to the unit interval rate, if necessary, generating a unit-interval clock 110 and a frame sync signal 111. Unit-interval clock 110 and frame sync signal 111 control the interface with memory 92 through DMA controller 94 to extract digitally-modulated symbols 52′ from memory 92 at the unit-interval rate. Unit-interval clock 110 and frame sync signal 111 also control the supply of digitally-modulated symbols 52′ to frequency-profiling circuit 54 at the unit-interval rate.

Unit-interval clock 110 and frame sync signal 111 are also routed off the semiconductor substrate 44 (FIG. 1) in which digital-processing circuit 22 is formed. Outside of semiconductor substrate 44, the conductive paths 112 and 112′ over which unit-interval clock 110 and frame sync signal 111 respectively travel serve as a synchronizer for clock domains 50′ and 50″, which would otherwise operate asynchronously from one another. Unit-interval clock 110 and frame sync signal 111 are then supplied back to semiconductor substrate 44 at a port-1 clock domain 50″, where they again control the extraction of digitally-modulated symbols 52″ from memory 92 and the supply of digitally-modulated symbols 52″ to frequency-profiling circuit 54. Any sample-rate generator 108″ present in port-1 clock domain 50″ need not be used. Accordingly, port-1 clock domain 50″ is forced to operate synchronously with port-0 clock domain 50′ so that the data collectively output by serial ports 50′ and 50″ during each unit interval are temporally aligned to properly form symbols 52″ as defined in table 82 (FIG. 5).

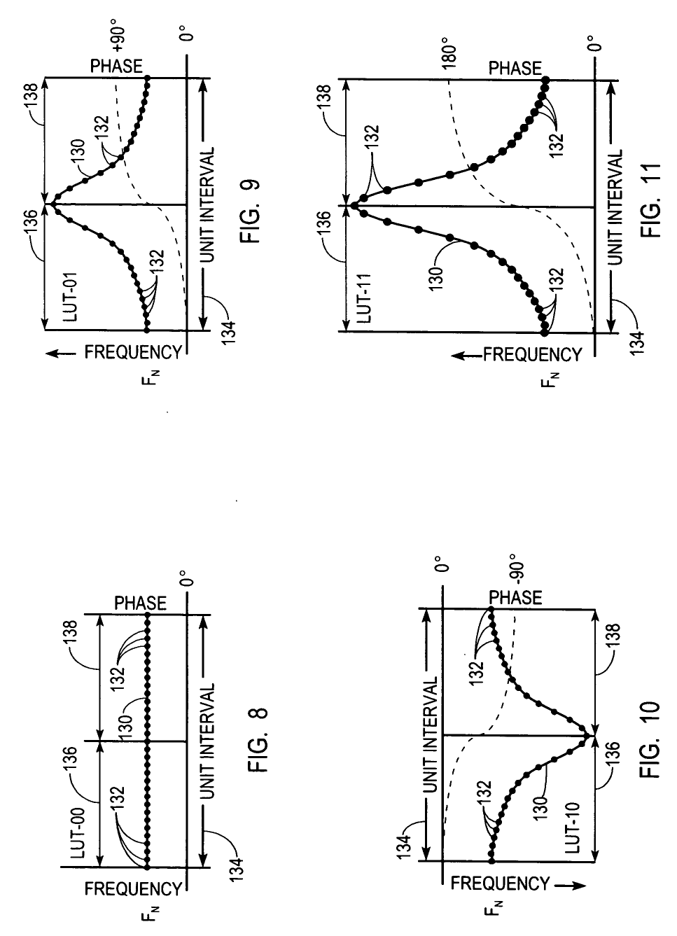

FIG. 7 shows a block diagram of DDS 24 which presents details omitted from FIG. 1. Frequency-profiling circuit 54, synthesizer 56, DAC 58, clock circuit 60, and division circuit 62 couple together as discussed above in connection with FIG. 1. But FIG. 7 shows synthesizer 56 and frequency-profiling circuit 54 in more detail.

Synthesizer 56 preferably includes a phase integrator 114 which includes an adder 116 having a first input serving as frequency input 66 and a second input coupled to an output of a delay element 118. An output of adder 116 drives an input of delay element 118. Delay element 118 imposes a one clock cycle delay, where the clock period in DDS 24 is shorter than the unit interval. The output of adder 116 also drives a phase-to-amplitude conversion circuit 120, which provides periodic output 68.

Technically, the data provided at frequency input 66 represents a phase, but synthesizer 56 integrates that phase into a periodic signal exhibiting a frequency corresponding to that phase. Thus, if a constant value is applied at frequency input 66, then a periodic signal of constant frequency is output at periodic output 68. In the preferred embodiment, phase-to-amplitude conversion circuit 120 converts integrated phase into a sinusoidal signal at periodic output 68.

Frequency-profiling circuit 54 includes an input port 122, an address counter 124, and a random access memory (RAM) 126. RAM 126 is configured by external programming from controller 38 (FIG. 1) or from a manufacturing facility into a plurality of look-up tables (LUT's) 128. For the QPSK example, four LUT's 128 are provided by RAM 126, with one LUT 128 being configured for each possible phase transition that a frequency-profile index symbol 52″ can describe (i.e., 0°, +900, −90°, or 180°). A data output from RAM 126 couples to frequency input 66 of synthesizer 56

Input port 122 is adapted to receive digitally-modulated, frequency-profile index symbols 52″, preferably supplied by digital-processing circuit 22 at a rate of one symbol per unit interval to conserve power consumption in digital-processing circuit 22. FIG. 7 depicts input port 122 being clocked by a reduced-rate clock signal output from division circuit 62 so that outputs from input port 122 remain static throughout a unit interval. For the QPSK modulation example, two bits of data are used to describe each digitally-modulated symbol 52″, and these two bits are routed through input port 122 to most-significant address bits of RAM 126. It is these two bits that select one of LUT's 128, and that selection remains in place from the beginning through the end of each unit interval.

Outputs from a counter 124 couple to least-significant address bits of RAM 126. Counter 124 counts cycles of the internal DDS clock, which clock exhibits a period less than the unit interval. Desirably, counter 124 is set to a predetermined value at the beginning of each unit interval. Thus, for each unit interval, counter 124 causes the selected LUT 128 to output different values programmed into that LUT 128, with the different values being output at each cycle of the internal DDS clock and in a predetermined sequence. For example, if transmitter 20 is configured so that 32 internal DDS clock cycles occur during each unit interval, then counter 124 may increment addressing for the selected LUT 128 from an address of zero through an address of 31 during each unit interval.

Each of FIGS. 8-11 graphically shows a different frequency profile 130 which may be implemented through frequency-profiling circuit 54 to accommodate the QPSK modulation example. Those skilled in the art will appreciate that different modulation formats may require different frequency profiles. Referring to FIGS. 7-11, one frequency profile 130 is depicted for each LUT 128 included in frequency-profiling circuit 54. Each frequency profile 130 includes a plurality of digitally-specified frequencies 132 for a unit interval 134. FIGS. 8-11 depict frequencies 132 as dots. When frequency-profiling circuit 54 outputs a frequency profile 130 over the duration of unit interval 134, synthesizer 56 generates a periodic signal having an output frequency that tracks the output frequency profile 130.

FIG. 8 depicts a frequency profile 130 that specifies a plurality of frequencies 132 arranged in a predetermined sequence wherein frequency does not vary over the duration of unit interval 134. Thus, the FIG. 8 frequency profile 130, when followed by synthesizer 56, causes synthesizer 56 to provide zero phase shift. The FIG. 8 frequency profile 130 would be suitable for phase transitions of 0° between unit intervals, as instructed by the frequency-profile index symbol “00” in accordance with the assignment of phase transition to index values set forth in FIG. 5.

FIG. 9 depicts a frequency profile 130 that specifies a plurality of frequencies 132 arranged in a predetermined sequence wherein frequency gradually increases over the course of an earlier subinterval 136 within unit interval 134, then gradually decreases over the course of a later subinterval 138 of unit interval 134. Desirably, the beginning and ending frequencies 132 of the frequency profile equal one another and also equal the beginning and ending frequencies 132 of all other frequency profiles 130. Frequencies 132 within this frequency profile are specified so that over the course of the unit interval 134 the synthesizer's periodic output will have changed a total of +90° in phase. The FIG. 9 frequency profile 130 would be suitable for phase transitions of +90° between unit intervals, as instructed by the frequency-profile index symbol “01” in accordance with the assignment of phase transition to index values set forth in FIG. 5.

FIG. 10 depicts a frequency profile 130 that specifies a plurality of frequencies 132 arranged in a predetermined sequence wherein frequency gradually decreases over the course of earlier subinterval 136, then gradually increases over the course of later subinterval 138. Desirably, the beginning and ending frequencies 132 of the frequency profile 130 equal one another and also equal the beginning and ending frequencies 132 from all other frequency profiles 130. Frequencies 132 within this frequency profile are specified so that over the course of the unit interval 134 the synthesizer's periodic output will have changed a total of −90° in phase. The FIG. 9 frequency profile 130 would be suitable for phase transitions of −90° between unit intervals, as instructed by the frequency-profile index symbol “10” in accordance with the assignment of phase transition to index values set forth in FIG. 5.

FIG. 11 depicts a frequency profile 130 that specifies a plurality of frequencies 132 arranged in a predetermined sequence wherein frequency gradually increases over the course of earlier subinterval 136, then gradually decreases over the course of later subinterval 138. Desirably, the beginning and ending frequencies 132 of the frequency profile 130 equal one another and also equal the beginning and ending frequencies 132 from all other frequency profiles 130. Frequencies 132 within this frequency profile are specified so that over the course of the unit interval 134 the synthesizer's periodic output will have changed a total of 180° in phase. The FIG. 9 frequency profile 130 would be suitable for phase transitions of 180° between unit intervals, as instructed by the frequency-profile index symbol “11” in accordance with the assignment of phase transition to index values set forth in FIG. 5.

Accordingly, for each frequency profile 130 that causes synthesizer 56 to change phase, the phase changes gradually over the course of each unit interval, as indicated by dotted-line trajectories depicted in FIGS. 9-11. This is accomplished by including for each unit interval 130 only a single increasing-frequency subinterval and only a single decreasing-frequency subinterval. In the QPSK example, +90° transitions place the increasing-frequency subinterval in earlier subinterval 136, and −90° transitions place the increasing-frequency subinterval in later subinterval 138.

FIG. 12 shows a graph depicting an exemplary spectral mask 140 that frequency-profiling circuit 54 can accommodate. Those skilled in the art will appreciate that regulatory and other requirements typically require RF transmitters to confine their spectral emissions within the limits of spectral mask 140 or the like. Spectral mask 140 forces transmitter 20 to reduce the spectrum its emissions would occupy if it used instantaneous or otherwise abrupt phase changes between unit intervals, as represented by an unmasked condition 142. Typically, spectral mask 140 is characterized by a bandwidth that closely corresponds to the inverse of a period of time marginally longer than the unit interval. The use of spectral masks prevents the emissions from one transmitter from interfering with communications that may be taking place in an adjacent frequency channel, allows adjacent channels to be located closer to one another in a given portion of the spectrum, and allows more channels to occupy the given portion of the spectrum.

The gradual phase changes achieved by frequency profiles 130 cause spectral emissions 144 from transmitter 20 to be confined within spectral mask 140. But those skilled in the art will appreciate that the precise trajectories followed by frequency profiles 130 are not critical features of the present invention. In other words, a wide variety of trajectories which may be presented by frequency profiles 130 will exhibit sufficient slowness of phase change so as to confine RF emissions within spectral mask 140.

In summary, the present invention provides an improved digital communications transmitter and method with synthesizer-controlled modulation. The pulse-shaping function which causes emissions to conform to a spectral mask and the IF/RF modulation function are combined to reduce power consumption. A digital synthesizer is controlled so that it provides pulse shaping in addition to IF/RF modulation. The significant power-consuming components are limited to a high-power amplifier (HPA) and two semiconductor devices.

Although the preferred embodiments of the present invention have been illustrated and described in detail, it will be readily apparent to those skilled in the art that various modifications may be made therein without departing from the spirit of the invention or from the scope of the appended claims.

What is claimed is:

1. A digital communications transmitter comprising:
a digital-processing circuit configured to generate a digitally-modulated symbol for each unit interval;
a frequency-profiling circuit configured to generate a plurality of digitally-specified frequencies per unit interval in response to each digitally-modulated symbol, said digitally-specified frequencies being configured to confine radio-frequency (RF) emissions within a predetermined spectral mask;
a digital synthesizer having a frequency input coupled to said frequency-profiling circuit and having a periodic output; and
a digital-to-analog converter having an input responsive to said periodic output of said digital synthesizer.

2. A digital communications transmitter as claimed in claim 1 wherein said frequency-profiling circuit is further configured to implement a frequency profile having, for each unit interval, only a single increasing-frequency subinterval and only a single decreasing-frequency subinterval.

3. A digital communications transmitter as claimed in claim 1 wherein said frequency-profiling circuit is further configured to implement a plurality of frequency profiles, wherein each frequency profile includes a plurality of digitally-specified frequencies for a unit interval.

4. A digital communications transmitter as claimed in claim 1 wherein said frequency-profiling circuit comprises a plurality of look-up tables, wherein each of said look-up tables is configured to produce a different frequency profile.

5. A digital communications transmitter as claimed in claim 4 wherein each digitally-modulated symbol selects one of said plurality of look-up tables.

6. A digital communications transmitter as claimed in claim 1 additionally comprising:
a constant-envelope amplifier coupled to said digital-to-analog converter; and
an antenna coupled to said constant-envelope amplifier.

7. A digital communications transmitter as claimed in claim 6 wherein said digital-processing circuit, said frequency-profiling circuit, said digital synthesizer, said digital-to-analog converter, and said constant-envelope amplifier are energized from a battery.

8. A digital communications transmitter as claimed in claim 1 wherein said digital-processing circuit has first and second clock domains which operate asynchronously from one another.

9. A digital communications transmitter as claimed in claim 8 wherein:
said first clock domain produces said digitally-modulated symbols at a data rate greater than one symbol per unit interval; and
said first clock domain occasionally operates in a standby mode until previously-generated symbols are output from said digital-processing circuit, wherein said standby mode causes said first clock domain to consume less power than is consumed when said first clock domain is not operated in said standby mode.

10. A digital communications transmitter as claimed in claim 8 wherein:
a memory is located in said digital-processing circuit at a boundary between said first and second clock domains;
said first clock domain causes said digitally-modulated symbols to be placed in said memory; and
said second clock domain uses direct memory access to extract said digitally-modulated symbols from said memory and supplies said digitally-modulated symbols to said frequency-profiling circuit.

11. A digital communications transmitter as claimed in claim 1 wherein:
said digital-processing circuit is formed on a first semiconductor substrate; and
said frequency-profiling circuit and said digital synthesizer are formed on a second semiconductor substrate which is different from said first semiconductor substrate.

12. A digital communications transmitter as claimed in claim 11 wherein said digital-to-analog converter is formed on said second semiconductor substrate.

13. A digital communications transmitter as claimed in claim 11 wherein:
said digital-processing circuit formed on said first semiconductor substrate has first and second clock domains which operate asynchronously from one another;
said second clock domain on said first semiconductor substrate operates synchronously with said frequency-profiling circuit and said digital synthesizer formed on said second semiconductor substrate; and
said second clock domain on said first semiconductor substrate provides an output port for said digital-processing circuit.

14. A digital communications transmitter as claimed in claim 11 wherein:
said digital-processing circuit formed on said first semiconductor substrate has first, second, and third clock domains;
said second clock domain provides a first serial port;
said third clock domain provides a second serial port; and
said digital communications transmitter additionally comprises a synchronizer coupled to said second and third clock domains of said digital-processing circuit, said synchronizer being configured to cause said third clock domain to operate synchronously with said second clock domain so that data collectively output by said first and second serial ports during each unit interval forms a symbol.

15. A digital communications transmitter as claimed in claim 14 wherein:
a first clock signal supplied to said second clock domain of said first semiconductor substrate is generated on said second semiconductor substrate; and
a second clock signal supplied to said third clock domain of said first semiconductor substrate is generated in said second clock domain of said first semiconductor substrate.

16. A digital communications transmitter as claimed in claim 1 wherein said digital-processing circuit is a programmable digital signal processor (DSP).

17. A digital communications transmitter as claimed in claim 16 wherein:
said programmable digital signal processor is configured to encode input data and to produce in-phase and quadrature baseband samples for each unit interval;
said programmable digital signal processor is configured to map said in-phase and quadrature baseband samples into a frequency-profile index for each unit interval; and
said programmable digital signal processor is configured to output said frequency-profile index for each unit interval as said digitally-modulated symbol.

18. A method of operating a digital communications transmitter comprising:
encoding input data so as to produce in-phase and quadrature baseband samples for a unit interval;
mapping said in-phase and quadrature baseband samples into a frequency-profile index;
selecting a frequency profile in response to said frequency-profile index, wherein said frequency profile specifies a plurality of frequencies in a predetermined sequence;
synthesizing a digital representation of a periodic signal throughout said unit interval in response to said frequency profile; and
converting said digital representation of said periodic signal into an analog signal.

19. A method as claimed in claim 18 additionally comprising:
providing circuits which perform said encoding and mapping activities on a first semiconductor substrate; and
providing circuits which perform said selecting and synthesizing activities on a second semiconductor substrate.

20. A method as claimed in claim 19 wherein:
said circuits which perform said encoding and mapping activities reside within a first clock domain on said first semiconductor substrate; and
said method additionally comprises transferring said frequency-profile index from said first semiconductor substrate to said second semiconductor substrate using a circuit which resides on said first semiconductor substrate within a second clock domain.

21. A method as claimed in claim 18 additionally comprising programming a frequency-profiling circuit to generate said frequency profile in response to said frequency-profile index.

22. A method as claimed in claim 21 wherein said programming activity is configured so that said frequency profile has only a single increasing-frequency subinterval and only a single decreasing-frequency subinterval.

23. A method as claimed in claim 18 additionally comprising programming a digital signal processor (DSP) to perform said encoding and mapping activities.

24. A method as claimed in claim 18 additionally comprising:
amplifying a signal derived from said analog signal in a constant-envelope amplifier to generate an amplified signal; and
broadcasting said amplified signal from an antenna.

25. A digital communications transmitter comprising:
a digital signal processor configured to encode input data so as to produce in-phase and quadrature baseband samples for each unit interval, to map said in-phase and quadrature baseband samples into a frequency-profile index for each unit interval, and to output said frequency-profile index for each unit interval;
a frequency-profiling circuit configured to generate a plurality of digitally-specified frequencies per unit interval in response to each frequency-profile index, said digitally-specified frequencies being configured to confine radio-frequency (RF) emissions within a predetermined spectral mask;
a digital synthesizer having a frequency input coupled to said frequency-profiling circuit and having a periodic output; and
a digital-to-analog converter having an input responsive to said periodic output of said digital synthesizer.

26. A digital communications transmitter as claimed in claim 25 wherein said frequency-profiling circuit, said digital synthesizer, and said digital-to-analog converter are formed on a common semiconductor substrate.

27. A digital communications transmitter as claimed in claim 25 wherein said frequency-profiling circuit is further configured to implement a plurality of frequency profiles, wherein each frequency profile specifies a plurality of frequencies in a predetermined sequence.
